(19) United States
(12) Patent Application Publication
(10) Pub. No.: US 2025/0124508 A1
(43) Pub. Date: Apr. 17, 2025

(54) METHOD FOR TRADING SHARES OF A WORK OF ART

(71) Applicant: HSIN-HUNG CHEN, Taichung City (TW)

(72) Inventor: HSIN-HUNG CHEN, Taichung City (TW)

(21) Appl. No.: 18/486,170

(22) Filed: Oct. 13, 2023

(51) Int. Cl. G06Q 40/04

(52) U.S. Cl. CPC G06Q 40/04

(57) ABSTRACT

To trade shares of a work of art, buyer and seller terminals are connected to a trading server. The seller terminal is used to post a work of art, set a type of right of the work of art, a type of an object of trade, a share of the work of art, a trade mode and seller's terms. The trading platform is used to display the work of art. The buyer terminal is used to search for the work of art and set buyer's terms. The trading server is used to match a buyer with a seller based on the seller's and buyer's terms. The trading server is used to execute a profit-sharing program and record an event of trade of the work of art.

### BACKGROUND OF INVENTION

### 1. Field of Invention

The present invention relates to trading of works of art and, more particularly, to a method for trading shares of a work of art.

### 2. RELATED PRIOR ART

Trading on the Internet is getting popular. There are various on-line shops. Many people use cellular phones or computers to trade various things via these on-line shops.

Works of art are cultural creations. Most artists are not good at promoting their works of art. Hence, it is difficult for artists to make decent livings by selling their works of art, and it is particularly so for young artists. It is not unusual that an artist is forced to sell his or her works of art at unreasonably low prices when he is young and unfamous. Price tags of large amounts of money can be given to such works of art years later when then artist is mature and famous. However, the artist never benefits properly from such works of art. Sometimes, such an artist is forced to buy his or her own works of art back at high prices when he or she is mature and famous.

When an artist is famous, his or her works of art are expensive. Such expensive works of art are not affordable for ordinary people no matter how good their tastes for art are. Ordinary people cannot invest on such expensive works of art. Liquidity of such expensive works of art is low.

The present invention is therefore intended to obviate or at least alleviate the problems encountered in the prior art.

### SUMMARY OF INVENTION

It is an objective of the present invention to provide a method for trading shares of a work of art.

It is another objective of the present invention to provide a method for trading shares of a work of art to improve liquidity of the work of art and increase the price of the work or art.

It is another objective of the present invention to provide a method for trading shares of a work of art to promote the work of art for educationally and financially.

To achieve the foregoing objectives, buyer and seller terminals are connected to a trading server. The seller terminal is used to post a work of art, set a type of right of the work of art, set a type of an object of trade, a type of an object of trade, a share of the work of art, a trade mode and seller's terms. The trading platform is used to display the work of art. The buyer terminal is used to search for the work of art and set buyer's terms. The trading server is used to match a buyer with a seller based on the seller's and buyer's terms. The trading server is used to execute a profit-sharing program and record an event of trade of the work of art.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a system for trading shares of a work of art;

FIG. 2 is a block diagram of the system shown in FIG. 1;

FIG. 3 is a flow chart of a method for trading shares of a work of art according to the preferred embodiment of the present invention;

FIG. 4 shows a series of images on a monitor of the system shown in FIG. 1 during a seller's process;

FIG. 5 shows a series of images on the monitor during a buyer's process;

FIG. 6 shows an image on the monitor during a matching process; and

FIG. 7 shows an image on the monitor when a transaction is completed.

### DETAILED DESCRIPTION OF PREFERRED EMBODIMENT

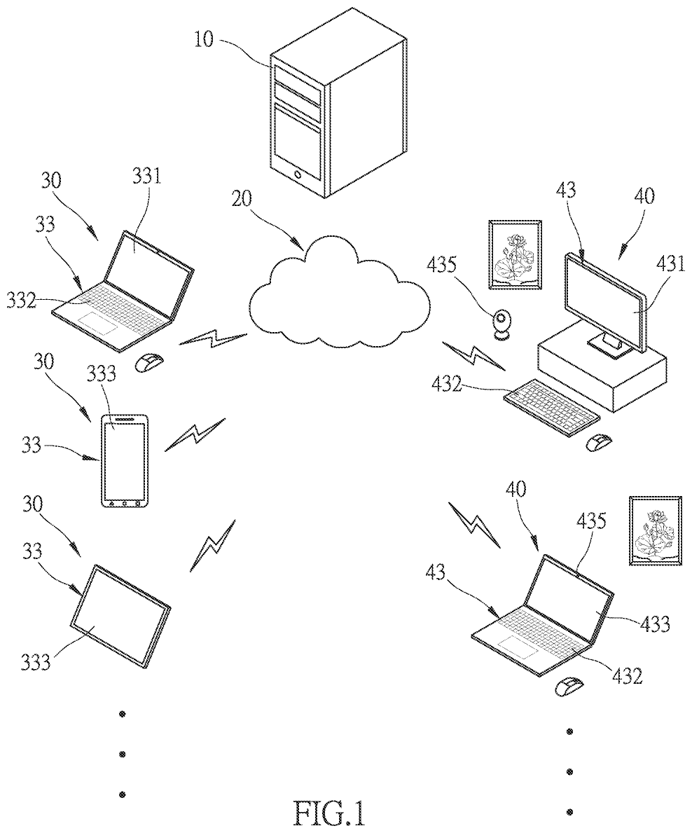

Referring to FIG. 1, a system for trading shares of a work of art includes a trading server 10, the Internet 20, at least one buyer terminal 30 and at least one seller terminal 40. The trading server 10 is connected to the buyer terminals 30 and the seller terminals 40 via the Internet 20. The connection is conducted by wires or in a wireless manner. Thus, buyers interact with sellers to complete on-line transactions of shares of works of art.

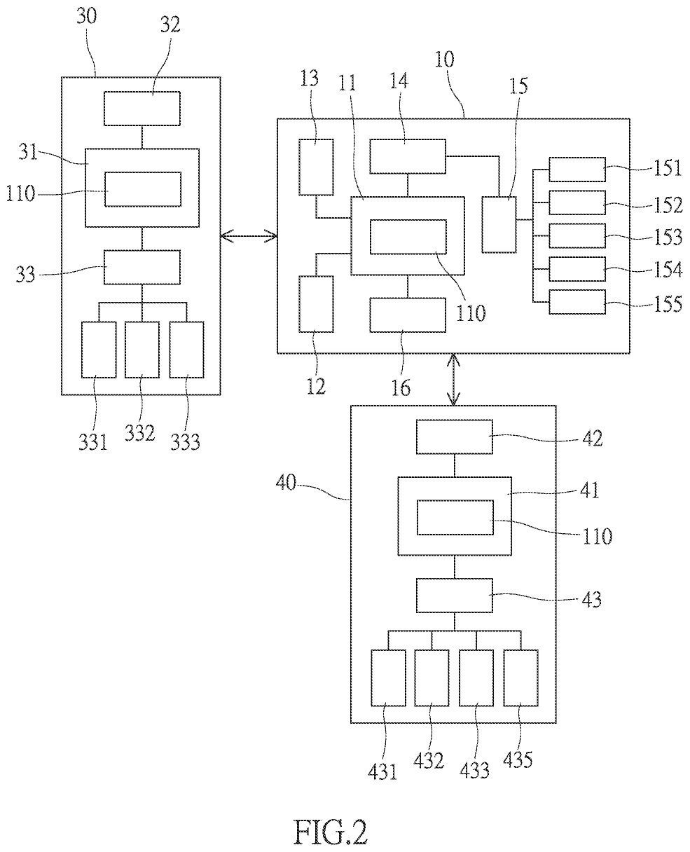

Referring to FIGS. 1 and 2, the trading server 10 includes a trade-processing module 11, a transceiver module 12, at least one memory unit 13, at least one storage unit 14 and a data module 15. The trade-processing module 11 is operable to execute programs, commands and functions in the system.

The transceiver module 12 is electrically connected to the trade-processing module 11. The transceiver module 12 is connected to the Internet 20 by wires or in a wireless manner. The transceiver module 12 is operable to transmit various data, images and/or commands to any of the buyer terminals 30 and the seller terminals 40. The transceiver module 12 is operable to receive various data, images and/or commands from any of the buyer terminals 30 and the seller terminals 40.

The memory unit 13 is electrically connected to the trade-processing module 11. The memory unit 13 is operable to store programs and/or commands in the system and temporarily store data about an operation system (software) or any other programs run in the system.

The storage unit 14 is electrically connected to the trade-processing module 11 by wires or in a wireless manner. The storage unit 14 is an internal storage device or external storage device.

The data module 15 is stored in the storage unit 14. The data module 15 includes a buyer database 151, a seller database 152, a work-of-art database 153, a share-holding database 154 and a transaction database 155. The buyer database 151 is operable to store various data of at least one buyer including but not limited to basic identification data, contact data, cashflow data and transaction data in the system.

The seller database 152 is operable to store various data about at least one buyer including but not limited to basic identification data, contact data, cashflow data and the transaction data in the system. Each of the buyers is an artist, owner or an agent (such as an art gallery and an auction house).

The work-of-art database 153 is operable to store various data about at least one work of art including but not limited to basic identification data, creation data, creator data, location data, video and/or audio data and the transaction data in the system. Each of the works of art is a painting, calligraphy, a Chinese ink painting, a sculpture, literature, a film, music or any other work of art.

The share-holding database 154 stores various data of at least one work of art about shares (or portions of ownership) of a work of art, share buyers and locations of storage.

The transaction database 155 is operable to store at least one works of art including but not limited to data about buyers and sellers, trade modes and profit-sharing trade modes.

The trade-processing module 11 further includes a cashflow unit 16. The cashflow unit 16 is operable to move money between bank accounts based on the transaction of shares of a work of art and the profit-sharing trade modes. For example, the cashflow unit 16 is operable to transfer money to a secured account from an account owned by a buyer to make sure that the buyer has enough money to complete the transaction. Then, the cashflow unit 16 transfers some of the money to an account owned by the seller and the rest of the money to an account owned by a trading platform according to a profit-sharing trade mode. Moreover, the trade-processing module 11 is operable to run trade-managing program 110 stored in the storage unit 14. The trade-managing program 110 is an application program for a web page on a website or a mobile application program run in any of the buyer terminal 30 or any of the seller terminal 40 to transmit data to the trading server 10 or receive data from the trading server 10. The trade-managing program 110 is run to allow the sellers to show data about works of art, the buyers to search for works of art, set trade modes and conditions and profit-sharing trade modes and conditions.

As mentioned above, the trading server 10, the buyer terminals 30 and the seller terminals 40 are in communication of data with one another via the Internet 10 by wires or in a wireless manner.

Each of the buyer terminals 30 is a cellular phone, a tablet computer, a laptop computer or a desktop computer held by a buyer. Each of the buyer terminals 30 includes a processing unit 31, a transmission unit 32 and an interface 33. The processing unit 31 is operable to execute the trade-managing program 110, various other programs, commands and functions. The transmission unit 32 is operable to transfer commands and/or the buyer's data to the trading server 10 from the processing unit 31 via the Internet 20.

The interface 33 is a monitor 331, a keyboard 332 or a touch panel 333 electrically connected to the processing unit 31. The interface 33 is operable to allow the buyer to review programs and data.

Each of the seller terminals 40 is a cellular phone, a tablet computer, a laptop computer or a desktop computer held by a seller. Each of the seller terminals 40 includes a processing unit 41, a transmission unit 42 and an interface 43. The processing unit 41 is operable to execute the trade-managing program 110, various other programs, commands and functions. The transmission unit 42 is operable to transfer commands or the seller's data to the trading server 10 from the processing unit 41 via the Internet 20 by wires or in a wireless manner.

The interface 43 is a monitor 431, a keyboard 432 or a touch panel 433 electrically connected to the processing unit 41. The interface 43 is operable to allow the seller to review programs and data. In addition, the interface 433 can include a camera 435 operable to take images of works of art. The images can be loaded on the Internet 20 later.

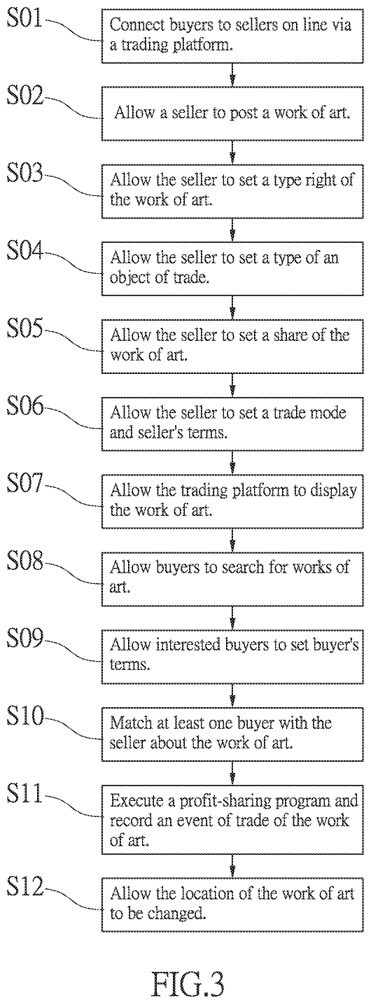

Referring to FIG. 3, a method for trading shares of a work of art executed in the system shown in FIGS. 1 and 2. The method is embodied in the trade-managing program 110. A seller uses the interface 43 of a seller terminal 40 to transfer data of a work of art to the trading server 10 via the Internet 20 to allow the trade-managing program 110, which is bult in the trading server 10, to display and sell the work of art. Buyers use their buyer terminals 30 to communicate with the trading server 10, which runs the trade-managing program 110, via the Internet 20 to allow the buyers to access to the data about the work of art and buy shares of the work of art. The trading server 10 records, stores and manage the trading of the shares of the work of art. Moreover, the trading server 10 provides statistics about the trading of the shares of the work of art.

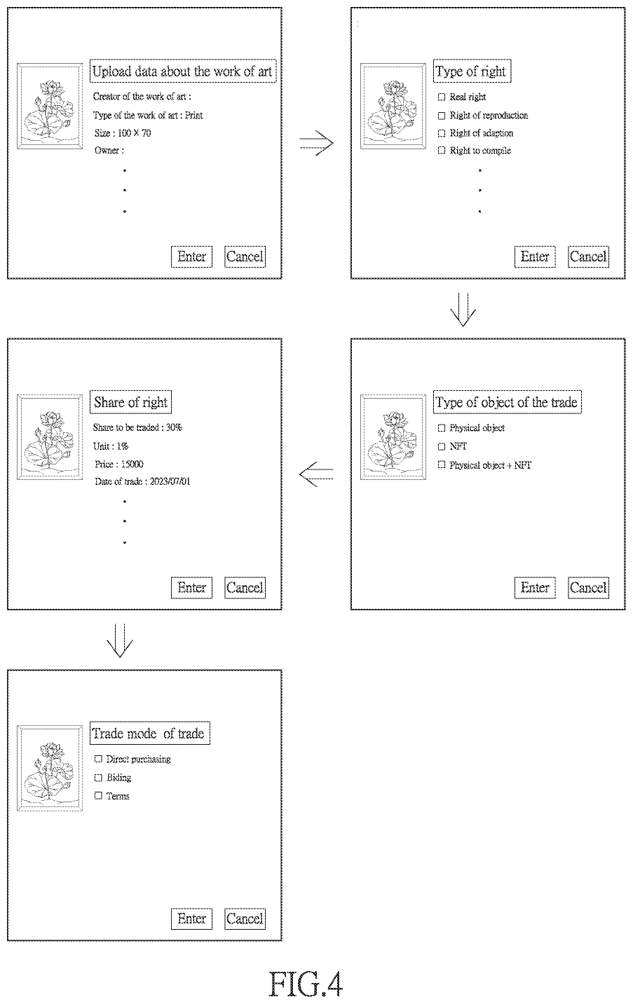

At S01, buyers are connected to sellers on line via a trading platform. Referring to FIG. 4, the trading platform turns on the trading server 10. Each of the buyers turns on his or her buyer terminal 30 at his or her discretion. Each of the sellers turns on his or her seller terminal 40 at his or her discretion. The buyer terminals 30 and the seller terminals 40 are connected to the trading server 10 via the Internet 20. The trading server 10 runs the trade-managing program 110 to transmit and/or receive data. Thus, the buyers and the sellers can register in or log on a website operated with the trade-managing program 110 run by the trading server 10 so that basic data of the buyers and/or sellers are stored in the buyer database 151 and/or seller database 152 of the data module 15 of the trading server 10.

At S02, at least one of the sellers is allowed to post at least one work of art. For briefness and clarity, the following description will be given to only one seller posting only one work of art. Referring to FIG. 4, the seller uses the interface 43 of the seller terminal 40 and runs the trade-managing program 110 built in the seller terminal 40 to transmit data about the work of art to the trading server 10. Then, the data about the work of art are stored in the work-of-art database 153 of the data module 15 of the trading server 10.

Referring to FIG. 4, at S03, the seller is allowed to set a type of right of the work of art. To this end, the seller is allowed to select from real right, right of reproduction, right of adaption, right to compile and full right for example. Then, the type of right of the work of art is stored in the work-of-art database 153.

Referring to FIG. 4, at S04, the seller is allowed to set a type of the object of trade. To this end, the seller is allowed to select from a physical object, a digital object such as a non-fungible token (NFT), and a combination of a physical object with a non-fungible token for example. For example, a painting or sculpture is traded, or a non-fungible token of the painting or sculpture is traded, or a combination of the painting or sculpture with a non-fungible token of the painting or sculpture is traded. For instance, the right of adaption of a piece of literature is traded alone. Then, the trade mode of the work of art is stored in the work-of-art database 153.

At S05, the seller is allowed to set a share of the work of art. Referring to FIG. 4, the share of the work is a sum of identical units. For example, each of the units is 0.1%, 1% or 2%, depending on the total value or price of the work of art. For example, the seller is allowed to sell 20% or 100% of the set type of right of the work of art. The set share of the work of art is stored in the work-of-art database 153.

At S06, the seller is allowed to set a trade mode and seller's terms for trading the share of the work of art. The trade mode is direct purchasing or biding for example. The seller's terms include a prize and a deadline for example. The trade mode and the seller's terms are stored in the work-of-art database 153.

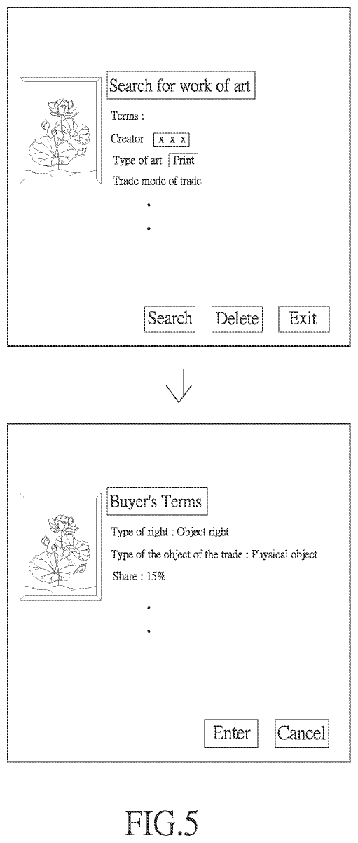

At S07, the trading platform is allowed to display the work of art. Referring to FIG. 5, after setting the type of right, the type of the object of trade, the trade mode, the seller's terms and the share, the trade-managing program 110 of the trading server 10 is executed to receive the data of the work of art from the work-of-art database 153 of the data module 15 before displaying the data or transferring the data to at least one buyer terminal 30 held by at least one buyer to allow the buyer to use the buyer terminal 30 to buy the work of art through the trade-managing program 110.

At S08, buyers are allowed to search for the work of art. Each of the buyers uses a buyer terminal 30 to search for a work of art initiatively or after receiving a notice from the trading server 10. To allow the trading server 10 to run the trade-managing program 110 to search for a work of art, each of the buyers uses a buyer terminal 30 to set keywords for a work of art. The trading server 10 runs the trade-managing program 110 to notify a buyer after finding a work of art according to the keywords.

At S09, buyers are allowed to set buyer's terms for trading a work of art. After finding a work of art, a buyer uses a buyer terminal 30 to set buyer's terms in the work-of-art database 153 of the trading server 10 in compliance with the type of right, the type of the object of trade, the trade mode, the seller's terms and the share of the work of art to be sold by the seller. Based on the buyer's terms, the cashflow unit 16 of the trading server 10 transfers an amount of money to a secured account from the buyer's bank account to guarantee the buyer having enough money for buying a share of the work of art.

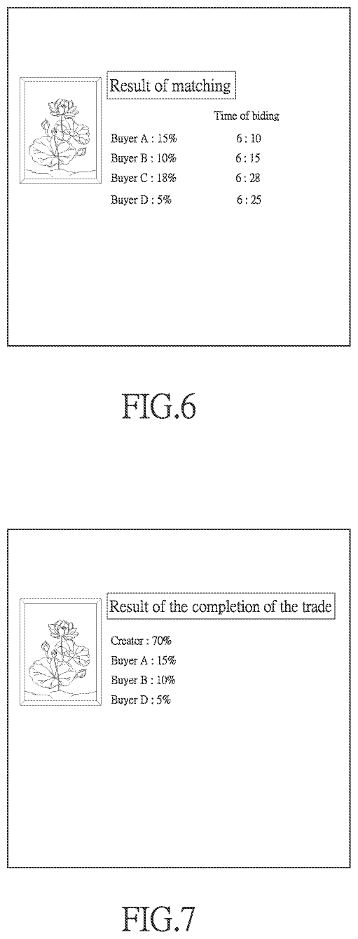

At S10, at least one buyer is matched with the seller about the work of art. After the buyers set the buyer's terms, the trading server 10 matches the seller's terms with the buyer's terms. For example, referring to FIG. 6, the seller intends to sell 30% of a work of art, and four buyers A, B, C and D respectively express their intention to buy 15%, and 10%, 18% and 5% of the work of art at 6:10, 6:15, 6:28 and 6:25. Preferably, referring to FIG. 7, the trade-managing program 110 run in the trading server 10 determines to allow buyers A, B and D to respectively buy 15%, 10% and 5% of the work of art.

At S11, based on the shares of the work of art held by the buyers, a profit-sharing program execute is executed, and an event trade of the work of art is recorded. For example, the share-holding database 154 of the data module 15 of the trading server 10 records that buyers A, B and D respectively own 15%, 10% and 5% of the work of art. The profit-sharing program stipulates that the trading platform is entitled to 10% of the profit and the seller is entitled to 90% of the profit for example. Accordingly, the cashflow unit 16 of the trading server 10 transfers 10% of the payment by each of buyers A, B and D to the trading platform from the secured account and 90% of the payment by each of buyers A, B and D to the seller. The cashflow unit 16 of the trading server 10 returns the payment by buyer C to buyer C from the secured account. This event of trade of the work of art is recorded in the share-holding database 154 of the data module 15 of the trading server 10. The event of trade of the work of art includes but not limited to the type of right, the type of the object of trade, the trade mode and the shares held by the buyers.

At S12, the location of the work of art is allowed to be changed. The seller, a single buyer or a group of buyers who owns the biggest share of the work of art is allowed to change the location of the work of art. In the foregoing example, after the trade, the seller owns 70% of the work of art and is hence allowed to change the location of the work of art. In another example in which a single buyer buys 51% of the work or art from the seller, the single buyer is allowed to change the location of the work of art. In another example in which two buyers respectively buy 25% and 30% of the work of art from the sellers, the buyers together are allowed to change the location of the work of art. Thus, it is likely that the work of art can be displayed in more places and appreciated by more people so that the value and liquidity of the work of art can be increased.

As discussed above, the method of the present invention allows a seller such as an artist to sell shares of a work of art to buyers. It is easy for an artist to make some money from a work of art to fund her or his creation of art in the future. Hence, it is not likely that an artist be forced to sell a work of art at an unreasonably low price when he or she is not famous. For a buyer, the entry level to the trade of works of art is lowered. That is, it is easier for a person interested in art to buy a share of a work of art. The liquidity and price of a work of art are increased. People are more willing to invest on works of art. The visibility of works of art is increased, and it is easier to promote works of art for financial and educational purposes.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A method for trading shares of a work of art comprising the following steps of:
providing a trading server with a trade-processing module, a transceiver module, at least one memory unit, at least one storage unit and a data module, wherein the storage unit stores a trade-managing program, wherein the trade-processing module runs the trade-managing program to display the work of art, search for the work of art and set terms for trading the work of art, wherein the data module comprises a buyer database, a seller database, a work-of-art database, a share-holding database and a transaction database;
providing at least one buyer terminal with a first processing unit for running the trade-managing program, a first transmission unit electrically connected to the first processing unit, and a first interface electrically connected to the first processing unit and operable to allow a buyer to review and enter data about the work of art;
providing at least one seller terminal with a second processing unit for running the trade-managing program, a second transmission unit electrically connected to the second, a second interface electrically connected to the second processing unit and operable to allow a seller to review the trade-managing program and enter data about the work of art, and a camera electrically connected to the second interface and operable for taking images of the work of art;
connecting the buyer and seller terminals to the trading server;
using the seller terminal to post a work of art;
using the seller terminal to set a type of right of the work of art;
using the seller terminal to set a type of an object of the trade;
using the seller terminal to set a share of the work of art;
using the seller terminal to set a trade mode and seller's terms for trading the share of the work of art;
using the trading platform to display the work of art;
using the buyer terminal to search for the work of art;
using the buyer terminal to set buyer's terms;
using the trading server to match a buyer with a seller based on the seller's and buyer's terms; and
using the trading server to execute a profit-sharing program and record an event of trade of the work of art.

2. The share-trading method according to claim 1, wherein the type of right is selected from the group consisting of real right, right of reproduction, right of adaption, right to compile and full right and digital right.

3. The share-trading method according to claim 1, wherein the type of the object of trade is selected from the group consisting of a physical object and a non-fungible token.

4. The share-trading method according to claim 1, wherein the trade mode is selected from the group consisting of direct purchasing and biding.

5. The share-trading method according to claim 1, wherein the step of using the buyer terminal to set buyer's terms comprises the step of providing a cashflow unit to transfer an amount of money to a secured account according the buyer's terms.

6. The share-trading method according to claim 1, wherein the step of using the trading server to match a buyer with a seller based on the seller's and buyer's terms comprises the step of matching the seller with multiple buyers.

7. The share-trading method according to claim 6, further comprising the step of using the trading server to allow the location of the work of art to be changed.

8. The share-trading method according to claim 7, wherein the step of using the trading server to allow the location of the work of art to be changed comprises the step of allowing one who owns the biggest share of the work of art to change the location of the work of art.

9. The share-trading method according to claim 1, wherein the trade-managing program comprises a website application program.

10. The share-trading method according to claim 1, wherein the trade-managing program comprises an application program executable in the buyer terminal and the seller terminal for communicate of data with the trading server.
